(19) United States
(12) Patent Application Publication
(10) Pub. No.: US 2005/0174947 A1
(43) Pub. Date: Aug. 11, 2005

(54) Method and process for video over IP network management

(76) Inventors: Hershy Beck, Brooklyn, NY (US); Michael Brandofino, Hillside, NJ (US); Randy Correa, North Bergen, NJ (US); Chaim Fried, Brooklyn, NY (US)

Correspondence Address: MORRISON & FOERSTER LLP, 1650 TYSONS BOULEVARD, SUITE 300, MCLEAN, VA, 22102, US

(21) Appl. No.: 11/033,472

(22) Filed: Jan. 12, 2005

Related U.S. Application Data
(60) Provisional application No. 60/535,547, filed on Jan. 12, 2004.
(60) Provisional application No. 60/535,548, filed on Jan. 12, 2004.

(51) Int. Cl. H04L 1/00

(52) U.S. Cl. 370/241; 370/394

(57) ABSTRACT

The invention is directed to systems and methods for testing performance of a packet-based network. In particular, the invention can be used to measure latency, packet loss, jitter and out-of-sequence packets. To measure the one-way timing issues such as the one-way latency, a highly accurate clock can be placed at the packet source and destination so that the time difference can be calculated with accuracy.

### FIELD OF INVENTION

This invention relates to systems and methods for testing packet-based networks used for real-time audio, video and data communication. The test systems and methods of the invention can simulate video traffic and measure network performance including traffic to and from customer premises equipment.

### BACKGROUND

Video over IP network management refers to a network testing methodology that addresses network metrics as they relate to videoconferencing. Most existing data networks were designed for applications that burst data and are delay-insensitive. In such a network, if a data packet arrives within a reasonable amount of time, both the application and the user are satisfied. Voice and video data, on the other hand, are very sensitive to delay. If a voice or video packet arrives more than approximately 200 milliseconds after it is transmitted, the packet may be worthless as a carrier of real-time communication because it will arrive too late to be used in the conversation or video image. Thus, video communications typically have more stringent requirements for performance metrics.

Additionally, video communications are distinct from other forms of communication because the packets transmitted may be variable in length and in the intervals between packets. Consequently, networks carrying IP voice and video must be designed and configured properly to ensure that real-time packets traverse the network efficiently. While network performance factors such as latency and packet loss are relevant to many different types of networks, the ability to monitor and manage jitter is particularly relevant for video communications.

If a network to be used for real-time video communications is tested using a conventional network testing model, the use of uniform packet sizes may allow many anomalies experienced due to load-balancing in network equipment at the microsecond level to go undetected. Thus, the high tolerances of real-time video communications require a network management methodology utilizing variable size packets and highly accurate clocks.

### SUMMARY OF THE INVENTION

Broadly described herein are systems and methods for testing networks for real-time audio, video and data communication over packet-based networks.

In one embodiment a method for measuring performance of a packet-based network can include generating a sequence of packets of variable size at a source, transmitting the sequence of packets from the source, storing the transmission time of a packet selected from the sequence of transmitted packets, receiving the selected packet at a destination and storing the reception time of the selected packet, and calculating the time difference between the transmission of the selected packet and the reception of the selected packet.

In another embodiment, a method for measuring performance of a packet-based network can include generating a sequence of packets of variable size at a source, transmitting the sequence of packets from the source and storing a parameter from a packet selected from the sequence at the time of transmission, receiving the selected packet at a destination and storing a parameter from the packet selected from the sequence at the time of reception, and calculating a network performance value based on a comparison of the parameter stored at the time of transmission and the parameter stored at the time of reception.

In yet another embodiment, a system for measuring performance of a packet-based network can include a packet sequence generator for generating a sequence of packets of variable size at a source, a packet sequence transmitter for transmitting the sequence of packets from the source, a receiver for receiving a packet selected from the transmitted sequence at a destination, a database for storing the transmission time and reception time of the packet selected from the sequence of transmitted packets, and a time difference calculator for calculating the time difference between the transmission of the selected packet and the reception of the selected packet.

In a still further embodiment, a system for measuring performance of a packet-based network can include a packet sequence generator for generating a sequence of packets of variable size at a source, a packet sequence transmitter for transmitting the sequence of packets from the source, a receiver for receiving a packet selected from the transmitted sequence at a destination, a database for storing a first parameter from the selected packet at the time of transmission and a second parameter from the selected packet at the time of reception, and a network performance value calculator for calculating a value based on a comparison of the parameter stored at the time of transmission and the parameter stored at the time of reception.

### BRIEF DESCRIPTION OF THE DRAWINGS

The invention may be better understood by reference to the Detailed Description of the Invention when taken together with the attached drawings, wherein:

FIG. 1 shows an exemplary full mesh configuration for testing network performance,

FIG. 2 shows an exemplary network configuration for testing network performance including the customer premises, and

FIG. 3 shows an exemplary integrated video over IP network configuration.

### DETAILED DESCRIPTION OF THE INVENTION

The present invention relates to systems and methods for testing and analyzing a network used for real-time audio, video and data communication over a packet-based network. The present invention enables the monitoring of various parameters relevant to this analysis. As described below, the invention can employ devices placed at customer premises and function as test gear, transmitting video packets to multiple locations. Traffic can be analyzed to detect various parameters and including, but not limited to, latency, packet loss, jitter, and other packet ordering anomalies pertinent to video over IP performance.

The systems and methods of the invention can be used in an IP network designed to support a high quality video conferencing service. As a non-limiting example, the testing methodology can be used in conjunction with a network including one or more gateways, bridges, ALUs and proxies that can be distributed across geographical areas to provide video services.

As mentioned above, several parameters are relevant to the performance of video over IP services. As non-limiting examples, these parameters include end-to-end latency, jitter, latency, packet loss and out-of-sequence packets.

End-to-End Latency

End-to-end latency refers to the total transit time for packets in a data stream to arrive at the remote endpoint. In some video network applications, the upper bound for latency for H.323 voice and video packets should not be more than 125-150 milliseconds. The average packet size for video packets is usually large (800-1500 bytes) while audio packet sizes are generally small (480 bytes or less). As a result, the average latency for an audio packet may be less than that for a video packet if routers or switches prioritize smaller packets over larger packets when encountering network congestion. Additionally, an H.323 video call can represent four streams—each station sending and receiving audio and video. Differences in latency of each stream may manifest itself as additional delay.

Jitter or Variability of Delay

Jitter refers to the variability of latencies for packets within a given data stream. Typically, a real-time video network should not allow jitter to exceed 20-50 milliseconds. For example, if a data stream in a 30 FPS H.323 session has an average transit time of 115 milliseconds and a single packet encountered a jitter of 145 milliseconds or more (relative to a prior packet), an underun condition may occur at the receiving endpoint, potentially causing either blocky, jerky video or undesirable audio. Too much jitter can cause also inter-stream latency problems discussed below.

Inter-Stream Latency

Inter-stream latency refers to the relative latencies that may be encountered between audio and video data streams. This metric may be based on how the relative average transit time for two or more streams, at any given point, vary from each other. As a result of inter-stream latency, an audio stream that arrives at an endpoint 30 milliseconds ahead of its video stream counterpart may produce detectable lip-synchronization problems. An audio stream that arrives later than its associated video stream data may have a slightly higher tolerance of 40 milliseconds before the loss of audio and video synchronization becomes generally detectable.

Packet Loss

This term refers to the loss or desequencing of data packets in a real-time audio/video data stream. A packet loss rate of 1% can produce a loss of approximately one fast video update per second and result in jerky video. Lost audio packets can produce choppy or broken audio. Since audio can typically operate with smaller packets at a lower bandwidth, in general, it is usually less likely to encounter packet loss. However, a 2% packet loss rate starts to render the video stream generally unusable and only minimally acceptable.

Out-of-Sequence Packets

Out of sequence packets typically occur when the packet stream is transmitted over multiple paths of unequal delay to a particular endpoint. Packets may arrive at the destination with incorrect ordering and must therefore be handled appropriately by the implementation or dropped.

Simulated Codec Testing

In one embodiment of the invention, test devices can be placed at strategic locations to simulate an H.323 codec video call. While this description of the invention is made with reference to the H.323 codec, one skilled in the art would recognize that the testing methods described may be applied to a wide variety of real-time communication protocols where the performance metrics discussed above are relevant.

According to the invention, a test can be run between two or more test devices. The test can simulate real video transmissions by varying factors including the packet size and/or packet length. The invention can also include a voice over IP call generator which can be capable of emulating the functionality of an H.323 terminal. Several H.323 simulators can be deployed to increase call volume to so that numerous simultaneous calls can be simulated.

In some embodiments, the simulator can include a complete H.323 implementation that enables benchmarking, load testing and verification of proper protocol implementation in voice over IP equipment. To simulate typical performance characteristics of video CODECs, the size of video-packets can be programmed and varied by the test administrator. In still further embodiments, the time between video-packets can also be programmed and varied by the test administrator.

The present invention allows IP performance metrics to be collected across a broad mesh of network paths. Through the use of highly accurate time sources such as GPS and CDMA clocks, packets transmitted from and received at various network points can be associated with very accurate time stamps. Test devices can be connected to time servers, achieving synchronization, which is useful for accurate measurement of statistics such as one-way latency. Video over IP network inquiries can report round trip and one-way latency measurements accurate to within one microsecond by taking advantage of hardware-based packet time stamping and GPS- or CDMA-based time synchronization. In some embodiments, time sources can be coupled to one or more POPs so that packets received at POP can be accurately time-stamped.

Deployment

The invention can be configured in a variety of deployment configurations.

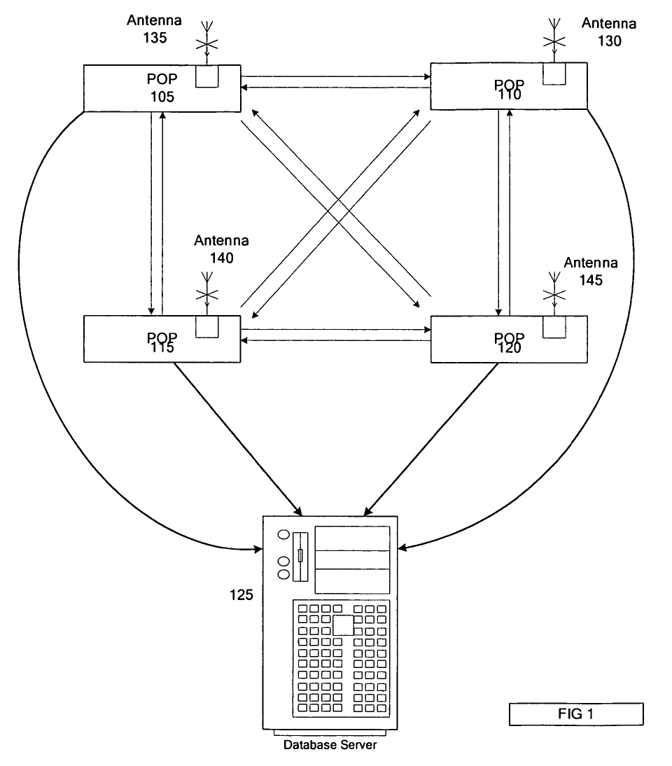

According to one embodiment, the deployment can be used to measure performance of the core or backbone network. One example of this embodiment is depicted in FIG. 1. According to this embodiment, test gear can be installed at POPs thereby creating a full mesh. In a full mesh design, each POP (105, 110, 115, and 120) can communicate with all other POPs. Networked devices can simulate H.323 calls to other test devices in the mesh. Results can then be sent by test devices to the database server (125) for analysis and reporting. The time sources described above (130, 135, 140, 145) can be integrated into one or more POPs so that one-way latency can be calculated accurately.

To calculate one-way latency with a high-degree of accuracy, the time recorded at a CDMA or GPS time source (110) packet recipient can be subtracted from the time recorded at a CDMA or GPS time source (105) sender. One skilled in the art will recognize that other accurate time sources could also be used.

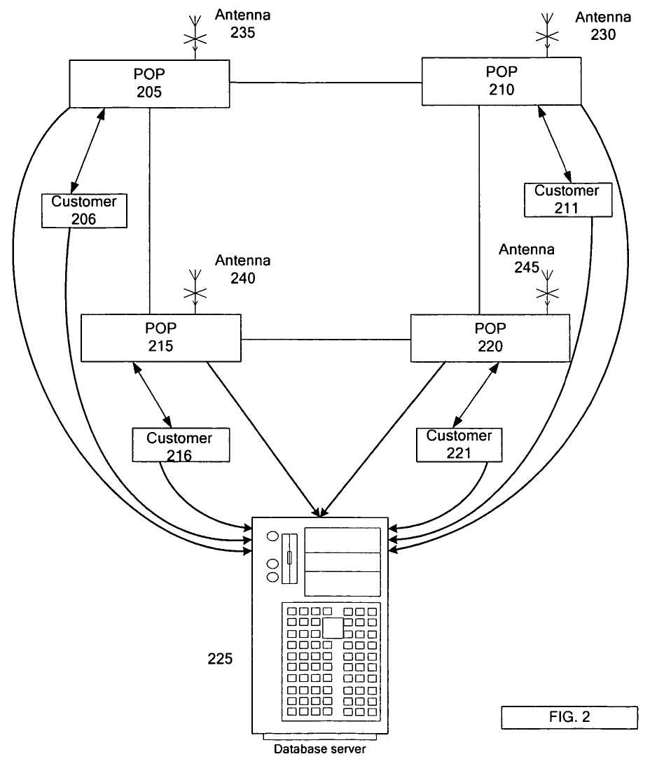

According to another embodiment, the test configuration can be configured to measure performance of individual customer links networked to one or more POPs. One example of this embodiment is depicted in FIG. 2. Test gear can be installed at one or more customer sites (206, 211, 216, 221) and the system can be can be configured to simulate an H.323 call from a customer device to a POP. As shown in FIG. 2, each POP can be configured to simulate a call from a customer site to the nearest POP. A customer site can be configured to include a software CODEC for the purposes of the network performance test. According to the embodiment shown in FIG. 2, a test of network performance for a packet originating at a first POP (205) and passing through a second POP (215) and terminating in a customer site (216) is not required to send one packet through all three devices in sequence. As an example, the present invention can measure a packet loss value from POP (215) to customer site (216) and then add this value to packet loss measured from POP (205) to POP (215).

One skilled in the art will recognize that the present invention can be configured to interface with a wide variety of database servers to store test data.

Network Architecture

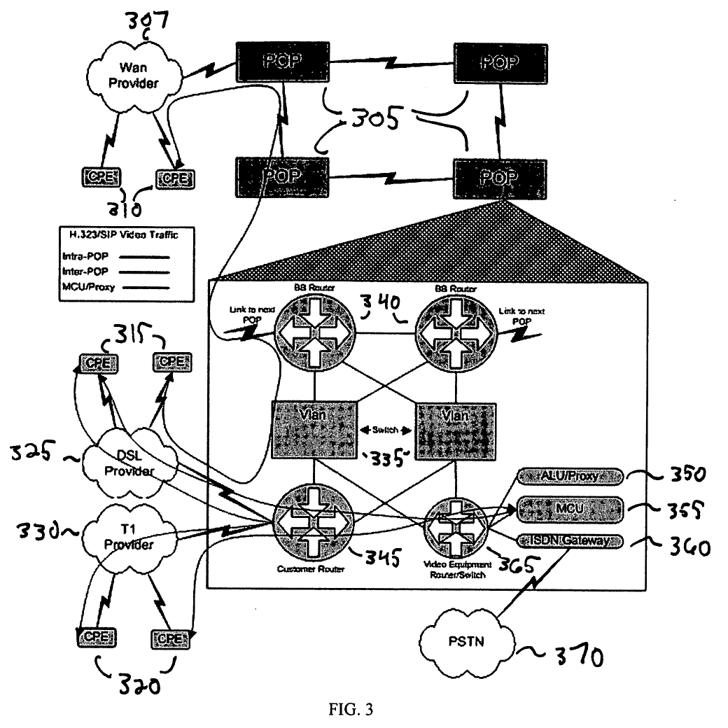

The systems and methods for testing a network described above can be used to examine performance of network components comprising part of an integrated video over IP network. An example of such an integrated network is shown in FIG. 3. As shown in FIG. 3, one or more POPs (305) can be in configured to communicate with each other. A POP (305) can also communicate with a wide-area network (WAN) provider (307) which can communicate with customer premises equipment (CPE) (310).

The POP (305) of the present invention can also be configured to communicate with one or more PSTNs (Public Switched Telephone Networks) (370) through an ISDN gateway (360) or another gateway known to one skilled in the art. The POP (305) can also communicate with a DSL provider (325) or a T1 provider (330). The DSL provider (325) and T1 provider (330) can be further configured to communicate with customer premises equipment (315) and customer premises equipment (320), respectively.

Internal to the POP, the present invention can also include one or more broadband routers (340) in communication with one or more VLANs (335), a customer router (345) and a video equipment router or switch (365). The video equipment router or switch (365) can be further configured to communicate with an ALU/proxy (350), an MCU (355) or and ISDN gateway (360).

Through the network architecture described above, various video over IP services can be provided. As non-limiting examples, these services can include video conferencing with without load-balancing or buffering. The services can also include direct inward dialing (DID) to and from endpoints in multiple area codes both on and off the network described above. The service provided can also include the use of ordinary telephone numbers to access a video conferencing endpoint.

One skilled in the art will recognize that the network architecture described above can be modified to include additional components or to function without one or more of the components illustrated.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A method for measuring performance of a packet-based network comprising:
generating a sequence of packets of variable size at a source,
transmitting the sequence of packets from the source,
storing the transmission time of a packet selected from the sequence of transmitted packets,
receiving the selected packet at a destination and storing the reception time of the selected packet, and
calculating the time difference between the transmission of the selected packet and the reception of the selected packet.

2. The method of claim 1 wherein the transmission time of the packet is received from a clock synchronized to an external time source.

3. The method of claim 2 wherein the external time source is a GPS clock.

4. The method of claim 2 wherein the external time source is a CDMA clock.

5. A method for measuring performance of a packet-based network comprising:
generating a sequence of packets of variable size at a source,
transmitting the sequence of packets from the source and storing a parameter from a packet selected from the sequence at the time of transmission,
receiving the selected packet at a destination and storing a parameter from the packet selected from the sequence at the time of reception, and
calculating a network performance value based on a comparison of the parameter stored at the time of transmission and the parameter stored at the time of reception.

6. The method of claim 5 wherein the network performance value represents latency.

7. The method of claim 5 wherein the network performance value represents packet loss.

8. The method of claim 5 wherein the network performance value represents jitter.

9. The method of claim 5 wherein the network performance value represents out-of-sequence arrival.

10. A system for measuring performance of a packet-based network comprising:
a packet sequence generator for generating a sequence of packets of variable size at a source,
a packet sequence transmitter for transmitting the sequence of packets from the source,
a receiver for receiving a packet selected from the transmitted sequence at a destination,
a database for storing the transmission time and reception time of the packet selected from the sequence of transmitted packets, and
a time difference calculator for calculating the time difference between the transmission of the selected packet and the reception of the selected packet.

11. The system of claim 10 further comprising a clock synchronized to an external time source for acquiring the transmission time of the selected packet.

12. The system of claim 10 wherein the external time source is a GPS clock.

13. The system of claim 10 wherein the external time source is a CDMA clock.

14. A system for measuring performance of a packet-based network comprising:
a packet sequence generator for generating a sequence of packets of variable size at a source,
a packet sequence transmitter for transmitting the sequence of packets from the source,
a receiver for receiving a packet selected from the transmitted sequence at a destination,
a database for storing a first parameter from the selected packet at the time of transmission and a second parameter from the selected packet at the time of reception, and
a network performance value calculator for calculating a value based on a comparison of the parameter stored at the time of transmission and the parameter stored at the time of reception.

15. The system of claim 14 wherein the network performance value represents latency.

16. The system of claim 14 wherein the network performance value represents packet loss.

17. The system of claim 14 wherein the network performance value represents jitter.

18. The system of claim 14 wherein the network performance value represents out-of-sequence arrival.
